(19) United States
(12) Patent Application Publication
(10) Pub. No.: US 2025/0175263 A1
(43) Pub. Date: May 29, 2025

(54) DETECTING RELATIVE DIRECTION OF AN ADJACENT DEVICE IN A NOISY ENVIRONMENT

(71) Applicants: Ofer HAREUVENI, Haifa (IL); Ehud Reshef, Kiryat Tivon (IL); David Birnbaum, Modiin (IL); Ofer Schreiber, Kryat Ono (IL)

(72) Inventors: Ofer HAREUVENI, Haifa (IL); Ehud Reshef, Kiryat Tivon (IL); David Birnbaum, Modiin (IL); Ofer Schreiber, Kryat Ono (IL)

(21) Appl. No.: 18/522,689

(22) Filed: Nov. 29, 2023

(51) Int. Cl. H04B 17/318; H04B 17/20

(52) U.S. Cl. CPC H04B 17/318; H04B 17/203

(57) ABSTRACT

An apparatus can include communications circuitry configured to receive a signal. The signal can have encoded thereon a plurality of data packets in a sequence with interpacket time differentials. The apparatus can include processing circuitry coupled to the receiver circuitry and to two or more antennas. The processing circuitry can responsive to determining that the interpacket time differentials correlate with a set of expected interpacket time differentials, measure relative signal strength of the signal at the two or more antennas. The processing circuitry can also determine a position or a distance of a second apparatus relative to the apparatus based on a comparison of measured signal strength at the two or more antennas. Other systems and methods are described.

### TECHNICAL FIELD

Embodiments described herein generally relate to computing systems, and in particular to providing common usage components on a device and an adjacent or companion device.

### BACKGROUND

Device users today often own two or more devices. Sometimes, users wish to use one device with another nearby device serving as an auxiliary device to provide auxiliary user input capabilities. A mutual knowledge of the relative position of the devices is important for accurate, user-friendly operation of auxiliary user input capabilities.

### BRIEF DESCRIPTION OF THE DRAWINGS

FIG. 1 illustrates example systems in which example aspects may be implemented.

FIGS. 2A and 2B illustrate example repeated sequence of packets in accordance with some aspects.

FIG. 3 is a function block diagram of an apparatus in accordance with some aspects.

FIG. 4 provides a further overview of example components within a computing device.

### DETAILED DESCRIPTION

Many people today own two or more computing devices. Often, a person will have at least one primary device (e.g., a personal computer, laptop, or similar device) and one or several smaller auxiliary devices such as smart phones, tablets, etc. In some situations, the user may wish to use an auxiliary device to access functions such as user interface or user input functions. For example, a user may want to access the display screen of an auxiliary Wi-Fi-enabled (or other communications-enabled) device. In addition, if the auxiliary device is equipped with other user input capabilities (e.g., touch pad, touch screen or connected joystick, touchpad, or mouse), these user input capabilities could be used to perform operations at the main (primary) device.

For proper operation of user activities such as drag-and-drop, multi-screen point, etc., the relative location of the auxiliary device and the primary device should be configured. This configuration may be done by the user or by automatic detection of the relative location of the auxiliary device to the primary device. Some available methods for detection rely on user configuration, but this can require multiple user steps and be prone to errors, leading to a degraded user experience.

Other available solutions use the antennas of the devices to estimate distances based on angle-of-arrival (AoA) or angle-of-departure (AoD) of signals, or other standards-based measurements. However, these solutions can be affected by noise (e.g., interference) in the vicinity of the primary and auxiliary device/s. Furthermore, not all devices necessarily support AoA and AoD protocols.

Other communications-based solutions are based on the capabilities of the receiving device to identify packet sent by the specific transmitting device based on packet header or content. However, security protocols or other protocols may prevent these solutions from operating correctly for all user devices. For example, with the increased usage of certain modern operating systems and Wi-Fi standards (e.g., 802.11bi, 802.11bh and 802.11be) privacy measures may prevent an application on a device from identifying the source of any given data packet source. Other encryption mechanisms may also be in place, further making it difficult for a device to identify a nearby device.

Still further communications-based solutions may reliably detect relative position and direction of devices based on Ultra-Wide-Band (UWB) technologies, but these are complex and expensive and therefore not provided on many low-end user devices.

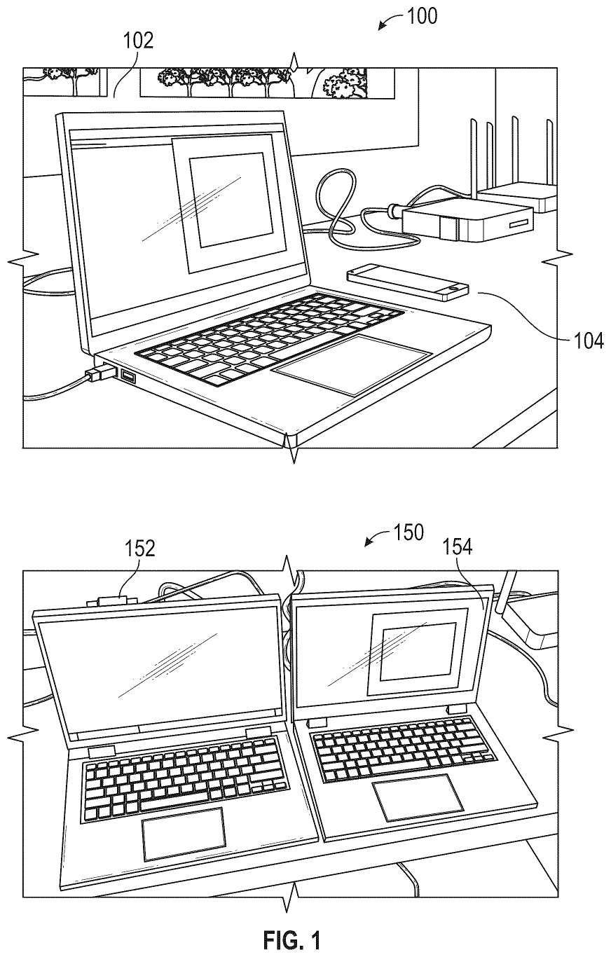

Aspects of this disclosure address these and other concerns by providing methods and apparatuses to detect frame transmissions from a companion device, based on negotiated or pre-defined characteristics of these transmissions. FIG. 1 illustrates example systems in which example aspects may be implemented.

A system 100 can include a primary device 102 in the form of a laptop and an auxiliary device 104 in the form of a smart phone. As a second example, a system 150 can include a primary device 152 in the form of a laptop and an auxiliary device 154 in the form of a second laptop.

The devices 102, 104, 152, 154 may not share the same wireless network and may not have any information regarding the identity of the other device as that identity might appear over wireless media. However, the devices 102, 104, 152, 154 are assumed to have the ability to exchange data with each other over the Internet, local network, or other data link (e.g., Bluetooth).

Each of the devices 102, 104, 152, 154 may have installed thereon an application (e.g., a software application) that can manage exchange of data and trigger specific operations for peer device identification and configuration. For example, certain applications can be installed on each device 102, 104, 152, 154 such as Multi Device Experiences (MDE) SW applications, so that the devices 102, 104, 152, 154 can exchange data and trigger synchronized operations subsequent to a triggering event. However, each device 102, 104, 152, 154 may have its own L1 (PHY) and L2 (MAC) type of network access, for example, any combinations of Wi-Fi, cellular or wired ethernet. In the case of both devices using Wi-Fi as their primary internet access L1/L2 layer, the devices can still connect to different Extended Service Set (ESS) networks or access points, or operate on different channels and bands, or under separate security domains. In some examples a triggering vent can include motion detection that detects presence of a second apparatus or movement of the main apparatus or second apparatus.

Further, at least one of the devices 102/104 or 152/154 should have more than a single antenna, so that the relative distance between one device transmitting antenna and the second device receiving antennas can be used to determine relative position between the devices 102, 104 or 152, 154. For example, one device 102/104 may be to the left or right or behind the other device 152/154. Distance can be estimated based on received signal strength indicators (RSSI) or by measuring time of flight, and direction can be determined based on a comparison of RSSI at each antenna.

The RSSI measurements should be averaged over multiple packets because, while the RSSI is correlated to the transmission distance, the RSSI is also susceptible to time-varying fading. As an example of a direction decision algorithm, if RSSI of an antenna on the left side of the primary device 102, 152 is significantly higher (for example above 3 dBm) than the RSSI of an antenna on the right side of the primary device 102, 152, then it will be assumed that the auxiliary device 104, 154 is left of the primary device 102, 152. The opposite can be assumed if the right-side antenna has a significantly higher RSSI than the left-side antenna.

Other decisions can be incorporated. For example, user input can be requested on the application executing on one or both of the primary device 102, 152 or auxiliary device 104, 154 as to whether the user wants to keep a previous setting, or if the devices are placed in a non-supported mode (e.g., the devices are placed above or below each other). Manual display settings can also be provided, for example, if signal strengths are too weak to make a positive determination of distance/direction, for any other reasons.

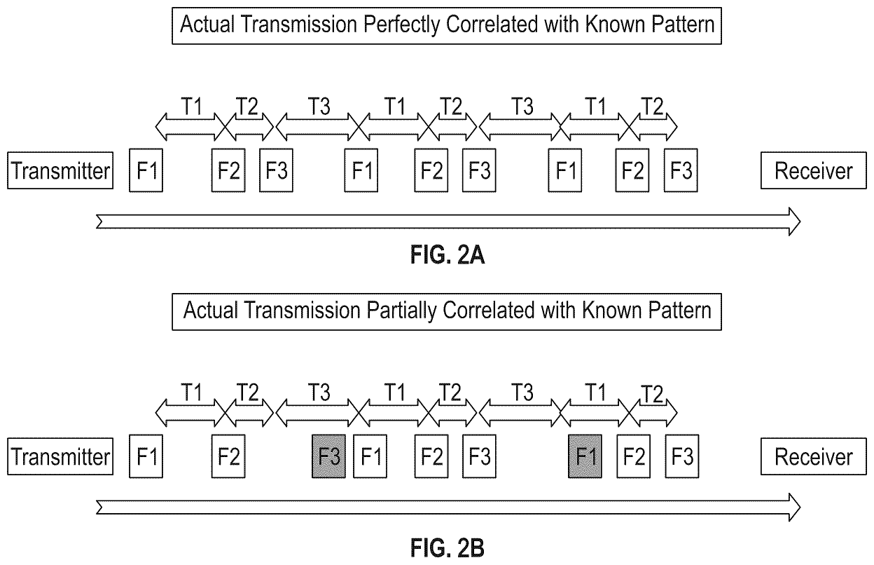

Upon triggering a detection flow (which is done at the application layer of the devices 102, 104, 152, 154), the auxiliary device 104, 154 (FIG. 1), as a transmitter, can transmit a repeated sequence of packets with a known (to both devices) pseudo-random target packet transmission time (or inter-packet spacing). FIGS. 2A and 2B illustrate example repeated sequences of packets in accordance with some aspects.

For example, if the randomly generated spacing sequence is [T1, T2, T3], the auxiliary device 104, 154 can send the packets [F1, F2, F3] N×M times (where M is the number of available Wi-Fi channels and N is the number of times to transmit the sequence on each of the M channels). The sequence [T1, T2, T3] can have pseudo-random values that would be generated by the transmitter (e.g., auxiliary device 104, 154) and notified to the receiver (e.g., primary device 102, 152).

The primary device 102, 152 can sequentially search over M channels, for a given time period that is aligned between the auxiliary device 104, 154 and primary device 102, 152, for a sequence having good inter packet time correlation to [T1, T2, T3]. Once such a sequence is identified with sufficient correlation, the primary device 102, 152 can use the RSSI per antenna for these packets to calculate the relative location of the auxiliary device 104, 154. By setting N>1, estimation of correlation can be improved where channel occupation or interference impact the auxiliary device 104, 154 ability to transmit in the specified, agreed-upon inter-packet spacing.

If each packet is received, as in FIG. 2A, correlation is high and the primary device 102, 152 can determine that the transmitting device is the auxiliary device 104, 154 for which RSSI calculations, etc. should be made. If no more than one packet is missed (e.g., if when one packet is missed, the next packet is still received) as shown in FIG. 2B, then as long as some inter-space packet times are still as expected, partial correlation may still be made and RSSI, etc. can be calculated.

A “listen before talk” (LBT) procedure can be implemented in L1 (PHY) of the Wi-Fi protocol, and the actual airtime of the transmitted packet may vary from the communicated pattern [T1, T2, T3]. These regulatory and standard requirements force the transmitter to sense that the media is free prior to transmission and if it is busy wait for a random time interval (backoff) once the media becomes free. It may comply with unlicensed spectrum standard and regulatory rules of “listen before talk” and may shift the actual transmission of a packet in case of carrier sense (air is occupied) by the minimum time required to enable the time sequence to be as close as possible to the requested sequence. Therefore auto-correlation of the received packets to the expected sequence might be below 100%. Still, if the pattern is repeated multiple times, confidence of identifying the packets transmitted by the companion device based on time-sequence correlation can be sufficiently high.

By using the correlation described above, the primary device 102, 152 can determine direction/distance to the auxiliary device 104, 154 regardless of the type of the auxiliary device 104, 154 and regardless of which operating system used by either the primary device 102, 152 or the auxiliary device 104, 154. Any device that has wireless support can include an application (e.g., aspects of this disclosure are implemented at the application layer) that can initiate transmissions over Wi-Fi by 1.) opening a socket and sending data packets, and 2.) initiate network discovery (scanning) that will results transmission of probe requests on at least a known list of Wi-Fi channels. Systems and methods according to aspects do not require the involved devices to be aware of the other device's MAC address or to have an awareness of PHY characteristics of packets transmitted by the other device (for example, a device does not need knowledge of transmission rate of data packets from the other device).

By using methods described above, a device can identify transmission of another device with unknown or random identity, out of multiple Wi-Fi transmissions from multiple sources (e.g., in a crowded Wi-Fi environment) by detecting a source of transmissions based on a synchronized randomly generated spacing sequence. If devices are moved, movement sensors such as inertial sensors can sense movement. Software applications executing on the devices can then trigger a re-calculation of direction/distance in response to this detection.

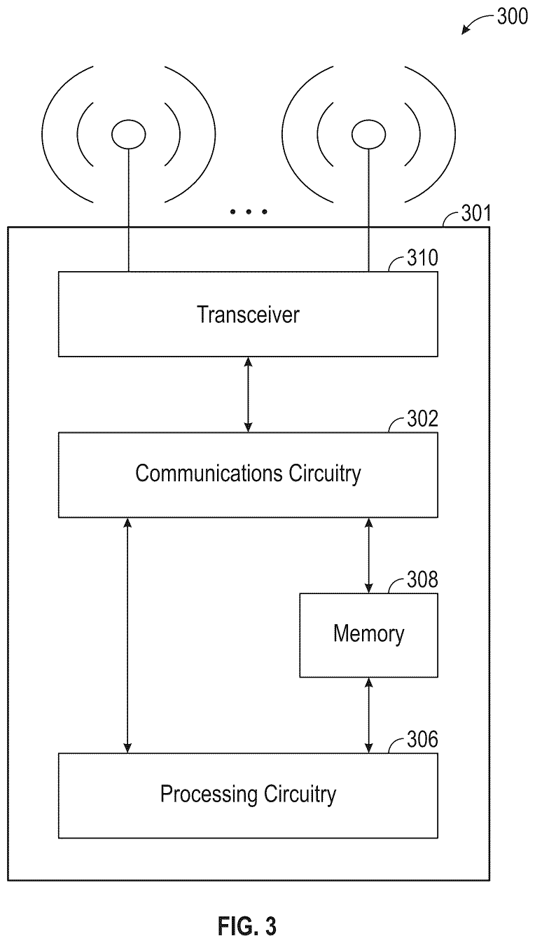

FIG. 3 illustrates a functional block diagram of an apparatus 300, in accordance with some aspects. In some aspects, the apparatus 300 may suitable as either the primary device 102, 152 or the auxiliary device 104, 154 of FIG. 1. For example, the apparatus can be appropriate for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device.

The apparatus 300 may include communications circuitry 302 and transceiver circuitry 310 for transmitting and receiving signals to and from other communication devices using two or more antennas 301. The communications circuitry 302 may include circuitry that can operate the physical layer (PHY) communications and/or medium access control (MAC) communications for controlling access to the wireless medium, and/or any other communications layers for transmitting and receiving signals. The apparatus 300 may also include processing circuitry 306 and memory 308 arranged to perform the operations described herein. In some aspects, the communications circuitry 302 and the processing circuitry 306 may be configured to perform operations detailed in the below figures, diagrams, and flows.

In accordance with some aspects, the communications circuitry 302 may be arranged to receive a signal, the signal having encoded thereon a plurality of data packets (e.g., [F1, F2, F3], FIG. 2A and FIG. 2B) in a sequence with interpacket time differentials (e.g., [T1, T2, T3] as described with respect to FIG. 2A and FIG. 2B).

In some aspects, the communication device may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some aspects, instead of two or more antennas, a single antenna with multiple apertures may be used. In these aspects, each aperture may be considered a separate antenna. In some multiple-input multiple-output (MIMO) aspects, the antennas may be effectively separated for spatial diversity and the different channel characteristics that may result between each of the antennas and the antennas of a transmitting device.

Although the communication device is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some aspects, the functional elements of the communication device may refer to one or more processes operating on one or more processing elements.

The processing circuitry 306, being coupled to the communications circuitry 302 and to two or more antennas 301, can detect relative position of an adjacent device (e.g., auxiliary device 104, 154 (FIG. 1)) in a noisy environment by correlating a set of expected interpacket time differentials with the actual received interpacket time differentials. If correlation is sufficient then RSSI measurements, etc. can be taken as described above to determine position/direction between devices. Consecutive instances of the sequence with interpacket time differentials and packet durations can be composed of changing intervals that are randomly generated, and the sequence is synchronized with the receiving primary device 102, 152. For example, durations of data packets can be defined to vary for different iterations of the sequence/s. In examples, correlation can include implementing statistical pattern matching to identify interpacket time differentials.

The processing circuitry 306 can receive information indicating the expected interpacket time differentials at an application layer of the apparatus 300. The processing circuitry 306 can control the communications circuitry 302 to scan a plurality of channels for the signal. The processing circuitry 306 can scan for a time period agreed upon with the second apparatus using the application layer.

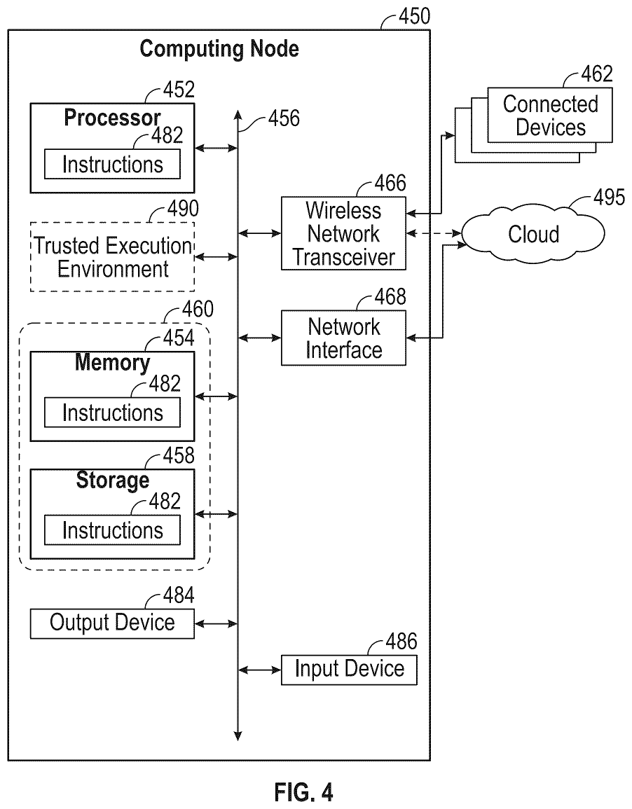

In a more detailed example, FIG. 4 illustrates a block diagram of an example of components that may be present in computing node 450 for implementing the techniques (e.g., operations, processes, methods, and methodologies) described herein. This computing node 450 provides a closer view of the respective components of apparatus 300 when implemented as or as part of a computing device (e.g., as a mobile device, a base station, server, gateway, etc.). The computing node 450 may include any combinations of the hardware or logical components referenced herein, and it may include or couple with any device usable with a communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the computing node 450, or as components otherwise incorporated within a chassis of a larger system.

The computing node 450 may include processing circuitry in the form of a processor 452, which may be a microprocessor, a multi-core processor, a multithreaded processor, an ultra-low voltage processor, an embedded processor, or other known processing elements. The processor 452 may communicate with a system memory 454 over an interconnect 456 (e.g., a bus). Any number of memory devices may be used to provide for a given amount of system memory. To provide for persistent storage of information such as data, applications, operating systems and so forth, a storage 458 may also couple to the processor 452 via the interconnect 456.

The components may communicate over the interconnect 456. The interconnect 456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 456 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 456 may couple the processor 452 to a transceiver 466, for communications with the connected devices 462. The transceiver 466 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected devices 462. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

A wireless network transceiver 466 (e.g., a radio transceiver) may be included to communicate with devices or services in the cloud 495 via local or wide area network protocols. A network interface controller (NIC) 468 may be included to provide a wired communication to nodes of the cloud 495 or to other devices, such as the connected devices 462 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 468 may be included to enable connecting to a second network, for example, a first NIC 468 providing communications to the cloud over Ethernet, and a second NIC 468 providing communications to other devices over another type of network.

Given the variety of types of applicable communications from the device to another component or network, applicable communications circuitry used by the device may include or be embodied by any one or more of components 466 or 468. Accordingly, in various examples, applicable means for communicating (e.g., receiving, transmitting, etc.) may be embodied by such communications circuitry.

In some optional examples, various input/output (I/O) devices may be present within or connected to, the computing node 450. For example, a display or other output device 484 may be included to show information, such as sensor readings or actuator position. An input device 486, such as a touch screen or keypad may be included to accept input. As described according to embodiments above, an output device 484 or input device 486 can be controlled to be operated concurrently with another nearby computing system or with the output device 484 of the other computing system. For example, user interface information can include a request to initiate an extended display session to provide a display of the second apparatus or computing device on a main display or display of the neighboring system.

An output device 484 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing node 450. A display or console hardware, in the context of the present system, may be used to provide output and receive input of a computing system; to manage components or services of a computing system; identify a state of a computing component or service; or to conduct any other number of management or administration functions or service use cases.

The storage 458 may include instructions 482 in the form of software, firmware, or hardware commands to implement the techniques described herein. Although such instructions 482 are shown as code blocks included in the memory 454 and the storage 458, it may be understood that any of the code blocks may be replaced with hardwired circuits, for example, built into an application specific integrated circuit (ASIC).

In an example, the instructions 482 provided via the memory 454, the storage 458, or the processor 452 may be embodied as a non-transitory, machine-readable medium 460 including code to direct the processor 452 to perform electronic operations in the computing node 450. The processor 452 may access the non-transitory, machine-readable medium 460 over the interconnect 456. For instance, the non-transitory, machine-readable medium 460 may be embodied by devices described for the storage 458 or may include specific storage units such as optical disks, flash drives, or any number of other hardware devices. The non-transitory, machine-readable medium 460 may include instructions to direct the processor 452 to perform a specific sequence or flow of actions, for example, as described with respect to the flowchart(s) and block diagram(s) of operations and functionality depicted above. As used herein, the terms “machine-readable medium” and “computer-readable medium” are interchangeable. The instructions 482 on the processor 452 (separately, or in combination with the instructions 482 of the machine readable medium 460) may configure execution or operation of a trusted execution environment (TEE) 490. In an example, the TEE 490 operates as a protected area accessible to the processor 452 for secure execution of instructions and secure access to data.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

### ADDITIONAL NOTES AND ASPECTS

Example 1 is an apparatus comprising: communications circuitry configured to receive a signal, the signal having encoded thereon a plurality of data packets in a sequence with interpacket time differentials; processing circuitry coupled to the receiver circuitry and to two or more antennas, the processing circuitry configured to: responsive to determining that the interpacket time differentials correlate with a set of expected interpacket time differentials, measure relative signal strength of the signal at the two or more antennas; and determine a position or a distance of a second apparatus relative to the apparatus based on a comparison of measured signal strength at the two or more antennas.

In Example 2, the subject matter of Example 1 can optionally include wherein the processing circuitry is configured to receive information indicating the expected interpacket time differentials at an application layer of the apparatus.

In Example 3, the subject matter of Example 2 can optionally include wherein the processing circuitry is configured to control the communications circuitry to scan a plurality of channels for the signal.

In Example 4, the subject matter of Example 3 can optionally include wherein the processing circuitry is configured to scan for a time period agreed upon with the second apparatus using the application layer.

In Example 5, the subject matter of Example 3 can optionally include wherein the processing circuitry is configured to scan a set of Wi-Fi channels, each for a given time period agreed upon with the second apparatus using the application layer.

In Example 6, the subject matter of any of Examples 1-5 can optionally include main display, and wherein the processing circuitry is configured to provide user interface information to the display indicative of the position or distance of the second apparatus relative to the apparatus.

In Example 7, the subject matter of Example 6 can optionally include wherein the user interface information includes a request to initiate an extended display session to provide a display of the second apparatus on the main display.

In Example 8, the subject matter of any of Examples 1-7 can optionally include wherein the plurality of data packets is received subsequent to a triggering event.

In example 9, the subject matter of Example 8 can optionally include wherein the triggering event includes a user input.

In Example 10, the subject matter of Example 8 can optionally include wherein the triggering event includes motion detection that detects the second apparatus.

In Example 11, the subject matter of any of Examples 1-10 can optionally include wherein the processing circuitry is configured to determine whether the interpacket time differentials correlate with a set of expected interpacket time differentials by implementing statistical pattern matching to identify interpacket time differentials.

Example 12 is an apparatus comprising: transmission circuitry; and processing circuitry coupled to the transmission circuitry, the processing circuitry configured to: trigger a detection sequence of data packets responsive to detecting an available transmission channel; and encode a signal for transmission using the transmission circuitry, the signal having encoded thereon a plurality of data packets in a sequence with interpacket time differentials.

In Example 13, the subject matter of Example 12 can optionally include wherein the processing circuitry is configured to receive information indicating expected interpacket time differentials at an application layer of the apparatus; and to configure the interpacket time differentials for transmission accordingly.

In Example 14, the subject matter of Example 13 can optionally include wherein the processing circuitry is configured to control the transmission circuitry to scan a plurality of channels for transmission, each channel for a time period agreed upon at the application layer.

In Example 15, the subject matter of claim 14 can optionally include wherein the processing circuitry is configured to perform a “listen before talk” LBT procedure before transmitting on a channel.

In Example 16, the subject matter of Example 15 can optionally include wherein the processing circuitry is configure to shift transmission of the sequence by a time duration responsive to sensing that the channel is busy.

In Example 17, the subject matter of Example 13 can optionally include wherein the expected interpacket time differentials are defined to vary for different iterations of the sequence and wherein the processing circuitry is configured to perform a synchronization operation subsequent to at least one iteration of the sequence.

In Example 18, the subject matter of Example 13 can optionally include wherein durations of the data packet are defined to vary for different iterations of the sequence and wherein the processing circuitry is configured to perform a synchronization operation subsequent to at least one iteration of the sequence.

Example 19 is a non-transitory computer-readable medium including instructions that, when executed on processing circuitry, cause the processing circuitry of a first apparatus to perform operations comprising any operations described above with reference to Examples 1-18.

Example 20 is a method comprising any operations described above with reference to Examples 1-18.

Example 21 is a system including means for performing any operations described above with reference to Examples 1-18.

The above detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are legally entitled.

We claim:

1. An apparatus comprising:
communications circuitry configured to receive a signal, the signal having encoded thereon a plurality of data packets in a sequence with interpacket time differentials;
processing circuitry coupled to the receiver circuitry and to two or more antennas, the processing circuitry configured to:
responsive to determining that the interpacket time differentials correlate with a set of expected interpacket time differentials, measure relative signal strength of the signal at the two or more antennas; and
determine a position or a distance of a second apparatus relative to the apparatus based on a comparison of measured signal strength at the two or more antennas.

2. The apparatus of claim 1, wherein the processing circuitry is configured to receive information indicating the expected interpacket time differentials at an application layer of the apparatus.

3. The apparatus of claim 2, wherein the processing circuitry is configured to control the communications circuitry to scan a plurality of channels for the signal.

4. The apparatus of claim 3, wherein the processing circuitry is configured to scan for a time period agreed upon with the second apparatus using the application layer.

5. The apparatus of claim 3, wherein the processing circuitry is configured to scan a set of Wi-Fi channels, each for a given time period agreed upon with the second apparatus using the application layer.

6. The apparatus of claim 1, further including a main display, and wherein the processing circuitry is configured to provide user interface information to the display indicative of the position or distance of the second apparatus relative to the apparatus.

7. The apparatus of claim 6, wherein the user interface information includes a request to initiate an extended display session to provide a display of the second apparatus on the main display.

8. The apparatus of claim 1, wherein the plurality of data packets is received subsequent to a triggering event.

9. The apparatus of claim 8, wherein the triggering event includes a user input.

10. The apparatus of claim 8, wherein the triggering event includes motion detection that detects the second apparatus.

11. The apparatus of claim 1, wherein the processing circuitry is configured to determine whether the interpacket time differentials correlate with a set of expected interpacket time differentials by implementing statistical pattern matching to identify interpacket time differentials.

12. An apparatus comprising:
transmission circuitry; and
processing circuitry coupled to the transmission circuitry, the processing circuitry configured to:
trigger a detection sequence of data packets responsive to detecting an available transmission channel; and
encode a signal for transmission using the transmission circuitry, the signal having encoded thereon a plurality of data packets in a sequence with interpacket time differentials.

13. The apparatus of claim 12, wherein the processing circuitry is configured to receive information indicating expected interpacket time differentials at an application layer of the apparatus; and to configure the interpacket time differentials for transmission accordingly.

14. The apparatus of claim 13, wherein the processing circuitry is configured to control the transmission circuitry to scan a plurality of channels for transmission, each channel for a time period agreed upon at the application layer.

15. The apparatus of claim 14, wherein the processing circuitry is configured to:
perform a “listen before talk” LBT procedure before transmitting on a channel, and shift transmission of the sequence by a time duration responsive to sensing that the channel is busy.

16. The apparatus of claim 13, wherein the expected interpacket time differentials are defined to vary for different iterations of the sequence and wherein the processing circuitry is configured to perform a synchronization operation subsequent to at least one iteration of the sequence.

17. The apparatus of claim 13, wherein durations of the data packet are defined to vary for different iterations of the sequence and wherein the processing circuitry is configured to perform a synchronization operation subsequent to at least one iteration of the sequence.

18. A non-transitory computer-readable medium including instructions that, when executed on processing circuitry, cause the processing circuitry of a first apparatus to perform operations comprising:
receiving a signal, the signal having encoded thereon a plurality of data packets in a sequence with interpacket time differentials;
responsive to determining that the interpacket time differentials correlate with a set of expected interpacket time differentials, measuring relative signal strength of the signal at two or more antennas; and
determining a position or a distance of a second apparatus relative to the apparatus based on a comparison of measured signal strength at the two or more antennas.

19. The non-transitory computer-readable medium of claim 18, wherein the operations further comprise:
receiving information indicating the expected interpacket time differentials; and
controlling receiver circuitry to scan a plurality of channels for the signal.

20. The non-transitory computer-readable medium of claim 19, further comprising scanning a set of Wi-Fi channels, each for a given time period agreed upon with the second apparatus.
